(19) United States
(12) Patent Application Publication
(10) Pub. No.: US 2011/0275967 A1
(43) Pub. Date: Nov. 10, 2011

(54) MASSAGING DEVICE

(76) Inventor: WEI-TING LIN, New Taipei City (TW)

(21) Appl. No.: 13/100,254

(22) Filed: May 3, 2011

(30) Foreign Application Priority Data
May 5, 2010 (TW) 099208315

(51) Int. Cl. A61H 23/02

(52) U.S. Cl. 601/108

(57) ABSTRACT

A massaging device comprises a tapping apparatus and a mounting apparatus for mounting the tapping apparatus. The tapping apparatus includes an actuating element, a flat tapping pad, and an elastic connecting assembly. The actuating element is mounted in the mounting apparatus and has a shaft connected with the flat tapping pad via the elastic connecting assembly. The actuating element can be energized or de-energized to have the shaft conduct a reciprocal motion to drive the flat tapping pad to repeatedly tap a portion of the human body. The elastic connecting assembly enables the flat tapping pad to have a uniform pressure distribution over entire surface of the pad that is in contact with a portion of the human body so that the effect of shaping body and reducing weight can be improved.

### (a) TECHNICAL FIELD OF THE INVENTION

The present invention relates to a massaging device and, more particularly, to a massaging device comprising a tapping apparatus that can produce a uniform pressure distribution over entire surface of a flat tapping pad that is in contact with a portion of the human body to improve the effect of shaping body and reducing weight.

### (b) DESCRIPTION OF THE PRIOR ART

Due to the economic development and the busy life, many people lack adequate exercise, and this may cause over-fat or obesity. Sometimes they feel pain in the loins and back. Thus, there are a lot of exercise equipments for busy persons in these times. However, the exercise equipments have no direct effect on the body shaping.

In conventional massage devices of tapping or impacting type, as can be seen in Taiwan Pat. No. M250659, M316730, M257189, 569780, 425868, and 364286, since the tapping force cannot be uniformly distributed over entire surface of the tapping pad to apply a uniform pressure onto a portion of the human body, the effect of shaping body and reducing weight is not good.

Based on long-term experiences and constant efforts on the development and innovation of massage products, the applicant has contrived an improved massage device that includes a tapping apparatus to overcome the drawback of the conventional massage devices.

### SUMMARY OF THE INVENTION

The primary object of the present invention is to provide a massaging device comprising a tapping apparatus that can apply a uniform tapping pressure on human body so that the effect of shaping body and reducing weight can be improved. According to the present invention, the massaging device comprises a tapping apparatus and a mounting apparatus for mounting the tapping apparatus. The tapping apparatus includes an actuating element, a flat tapping pad, and an elastic connecting assembly. The actuating element is mounted in the mounting apparatus and has a shaft connected with the flat tapping pad via the elastic connecting assembly. The actuating element can be energized or de-energized to have the shaft to conduct a reciprocal motion so as to drive the flat tapping pad to repeatedly tap a portion of the human body. The elastic connecting assembly enables the flat tapping pad to have a uniform pressure distribution over entire surface of the pad that is in contact with the portion of the human body so that the effect of shaping body and reducing weight can be improved.

Other objects, advantages, and novel features of the present invention will become more apparent from the following detailed description when taken in conjunction with the accompanying drawings.

### BRIEF DESCRIPTION OF THE DRAWINGS

FIG. 1 is a 3-dimensional view of the present invention.

FIG. 2 is an exploded view of the present invention.

FIG. 3 is a sectional view of the present invention.

FIG. 4 is a sectional view schematically showing the present invention employed on human body.

FIG. 5 is a partially sectional view schematically showing the present invention employed on human body

FIG. 6 is a partially sectional view schematically showing the flat tapping pad is compressing one portion of the human body.

FIG. 7 is a partially sectional view schematically showing the compressed spring exerting a counteracting force to the connecting plate driven by the shaft of the actuating element.

FIG. 8 is a partially sectional view schematically showing the shaft of the actuating element returned to its original position together with the connecting plate.

FIG. 9 is plan view showing that the massaging device of the present invention is fastened to the waist of human body.

FIG. 10 is plan view showing that the massaging device of the present invention is fastened between the shoulder and the opposing underarm of human body.

FIG. 11 is a sectional view showing another preferred embodiment of the present invention.

### DETAILED DESCRIPTION OF THE PREFERRED EMBODIMENTS

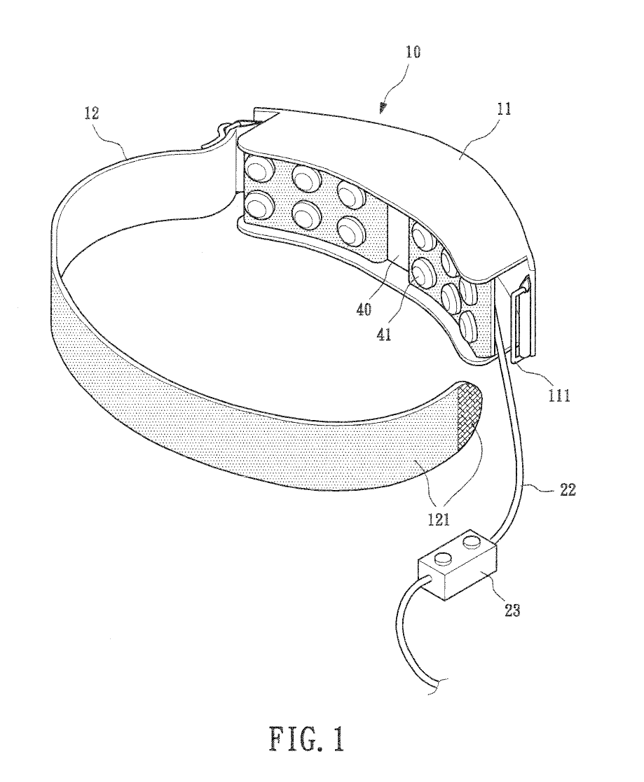

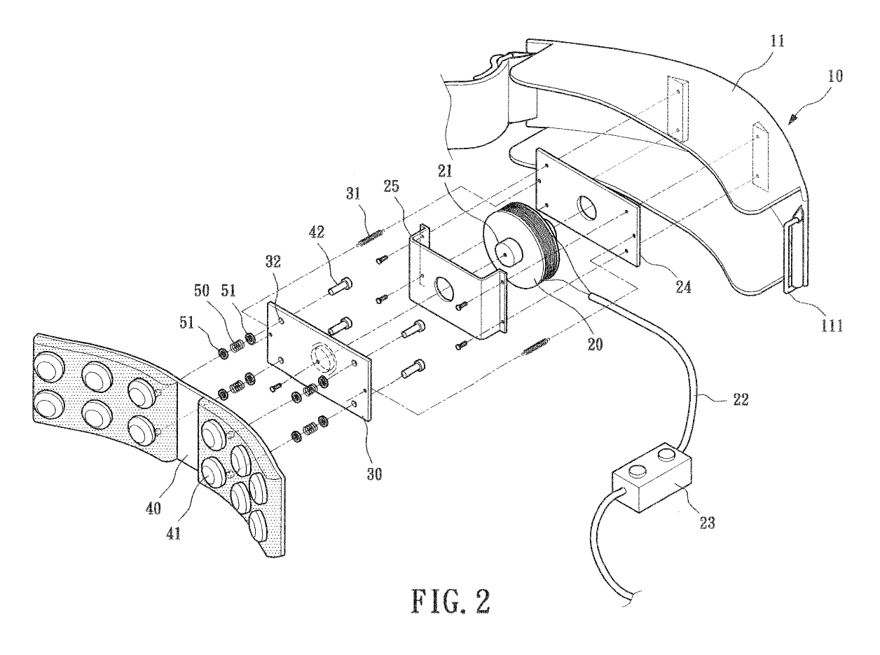

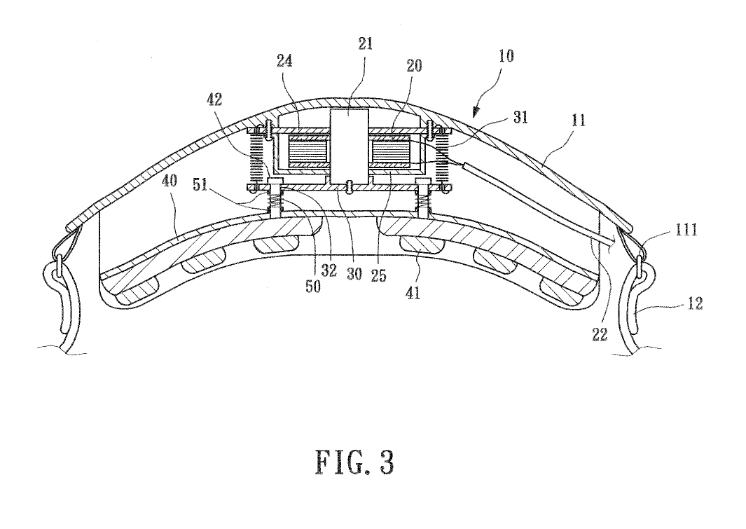

Please refer to FIGS. 1, 2 and 3, in which a preferred embodiment of a massaging device according to the present invention is shown. The massaging device generally comprises a tapping apparatus and a mounting apparatus 10 for mounting the tapping apparatus. As shown, the tapping apparatus including an actuating element 20, a flat tapping pad 40, and an elastic connecting assembly that includes a connecting plate 30 defining a plurality of through holes 32 symmetrically around the periphery thereof, a plurality of guiding rods 42, a plurality of springs 50, and a plurality of washers 51. The actuating element 20 can drive the flat tapping pad 40 to move forth and back so as to repeatedly tap a portion of the human body. As the flat tapping pad taps a portion of the human body, the elastic connecting assembly enables the flat tapping pad 40 to have a uniform pressure distribution over entire surface of the pad so that the effect of shaping body and reducing weight can be improved. Detailed description for the above components will proceed in the following paragraphs.

The mounting apparatus 10 includes a case 11 and a strap 12. The strap 12 has a first end fixedly attached to the case 11 and a second end opposing to the first end. An outer surface of the strap 12 is provided with a pair of fasteners 121 capable of fastening with each other, one fastener being located at the second end and the other fastener being provided along a length of the outer surface of the strap 12. The strap 12 can wrap a portion of human body and loop a clasp 111 of the case 11 to have the pair of fasteners fastened together, such that the tapping apparatus can be fasten onto the portion of human body.

The actuating element 20 includes a shaft 21, which is an electromagnet in this embodiment, and a coil. The actuating element 20 is enclosed with a cover 25 and a mounting plate 24, and secured to the case 11 by means of screws. When the coil of the actuating element 20 is energized, the shaft 21 of the actuating element 20 can move forth or outward. When the coil of the actuating element 20 is de-energized, the shaft 21 of the actuating element 20 can move back or inward. In other words, the actuating element 20 can be energized or de-energized to have the shaft 21 to conduct a reciprocal motion such that the flat tapping pad 40 can be driven to repeatedly tap a portion of the human body. Furthermore, the actuating element 20 is electrically connected with a control unit 23 by wires 22, which can control the on and off of a power supply for controlling the movement of the shaft 21.

The connecting plate 30 is secured to the outward end of the shaft 21. Two springs 31, being of extension spring, are symmetrically connected between the connecting plate 30 and the mounting plate 24. The springs 31 can assist the connecting plate 30 to move more smoothly together with the shaft 21 in operating the tapping apparatus.

The flat tapping pad 40, which is made of elastic material in this embodiment, is provided with multiple massage heads 41 on the surface that is in contact with one portion of the human body. Each guiding rod 42 is slidably inserted in a respective through hole 32 of the connecting plate 30 at one end thereof, and fixedly connected with the flat tapping pad 40 at the other end thereof. The guiding rods 42 each has a head portion having a dimension greater than the respective through hole 32 to serve as a stopper, thereby preventing it from disconnecting from the connecting plate 30. The springs 50, being of compression spring, are each fitted around a respective guiding rod 42 between the connecting plate 30 and the flat tapping pad 40. Two washers 51 are fitted around each guiding rod 42 at two ends of a respective spring 50. When the flat tapping pad 40 taps a portion of human body, due to the compressions of the springs 50, the springs 50 each can exert a counteracting force to the connecting plate 30 to enable the flat tapping pad 40 to have a uniform pressure distribution over entire surface of the flat tapping pad that is in contact with the portion of human body.

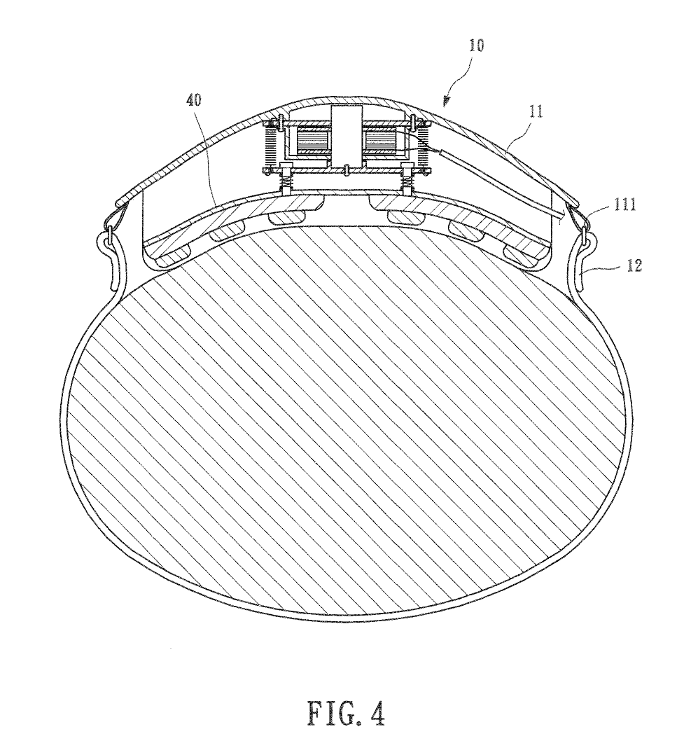

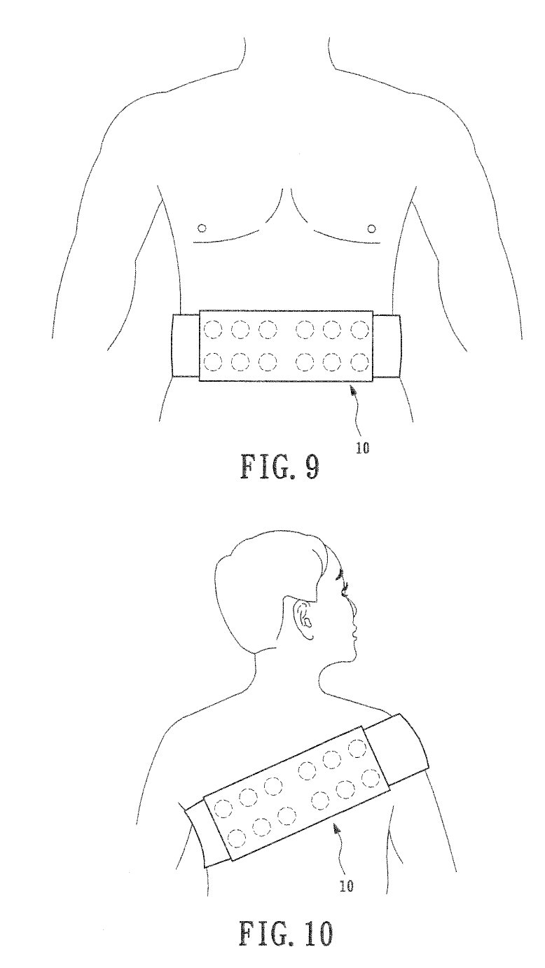

As shown in FIGS. 4 and 9, a user can easily adjust the mounting apparatus 10 to have the strap 12 wrapped the waist or abdomen to secure the tapping apparatus to that portion.

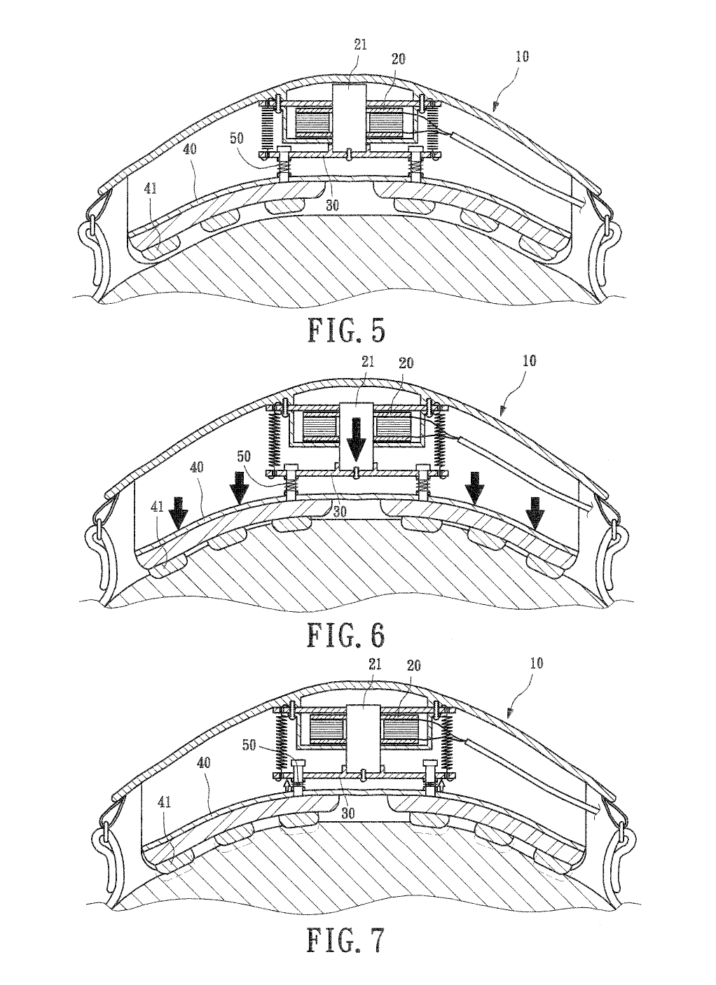

As shown in FIGS. 5, 6 and 7, when the actuating element 20 is energized, the shaft 21 can move forth or outward together with the connecting plate 30 to drive the flat tapping pad 40 to tap a portion of the human body. When the flat tapping pad 40 taps the portion of the human body, the springs 50 can be compressed by the flat tapping pad 40 at the same time to enable the springs 50 to each exert a counteracting force to the connecting plate 30 to cause the flat tapping pad 40 to have a uniform pressure distribution over entire surface of the flat tapping pad that is in contact with the portion of the human body so that the effect of shaping body and reducing weight can be improved.

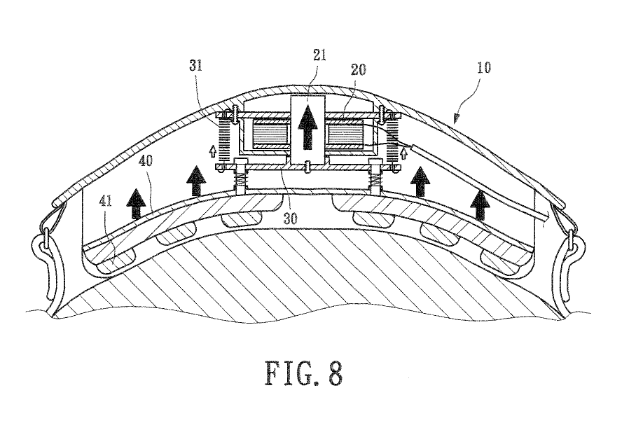

As shown in FIG. 8, when the actuating element 20 is de-energized, the shaft 21 can move back or inward together with the connecting plate 30 with the aid of the flat tapping pad 40. In such condition, each spring 31, being in a stretching state, can exert a counteracting force to the connecting plate 30 to enable the connecting plate 30 to move more smoothly.

As shown in FIG. 10, a user can easily adjust the mounting apparatus 10 to have the strap wrapped between the shoulder and the opposing underarm of the human body.

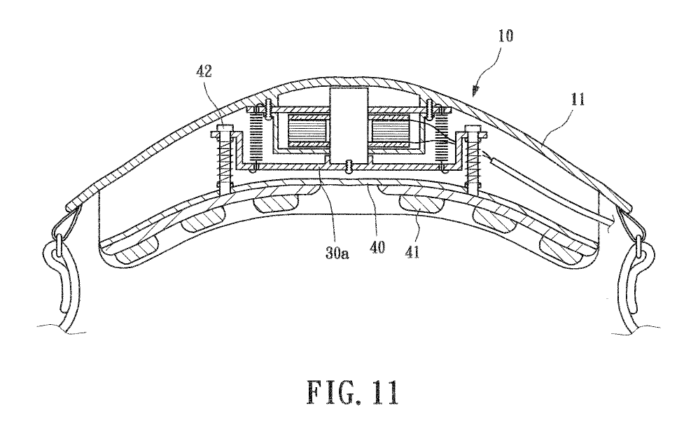

FIG. 11 presents another preferred embodiment of the present invention. As shown, the connecting plate 30a is formed into a substantially U-shaped member having two lateral edges each defining a plurality of through holes. This design can reduce the distance between the connecting plate 30a and the flat tapping pad 40 such that the thickness of the case 11 can be reduced.

Although the present invention has been described with a certain degree of particularity, it is understood that the present disclosure is made by way of example only and the combination and arrangement of parts may be resorted to without departing from the spirit and scope of the invention hereinafter claimed.

I claim:

1. A massaging device comprising a tapping apparatus and a mounting apparatus for mounting said tapping apparatus, said tapping apparatus including an actuating element, a flat tapping pad, and an elastic connecting assembly, said actuating element containing a coil and a shaft that can move forth or back by energizing or de-energizing said coil, said actuating element mounted in said mounting apparatus, said shaft of said actuating element connected with said flat tapping pad via said elastic connecting assembly, said flat tapping pad facing to an opening of said mounting apparatus for being contact with a portion of human body, said actuating element allowed to be energized to have said flat tapping pad move outward of said mounting apparatus through said opening to tape a portion of human body, said actuating element allowed to be de-energized to have said flat tapping pad move inward of said mounting apparatus; whereby, when said flat tapping pad taps a portion of human body, said flat tapping pad has a uniform pressure distribution over entire surface thereof in contact with the portion of human body so that the effect of shaping body and reducing weight can be improved.

2. The massaging device of claim 1, wherein said mounting apparatus includes a case and a strap wherein said strap have a first end fixedly attached to said case and a second end opposing to the first end, said strap has an outer surface provided with a pair of fasteners, one of which is located at the second end of said strap and the other of which is located along a length of the outer surface of said strap, the pair of fasteners capable of fastening with each other, such that said strap can wrap a portion of human body and loop a clasp of said case to have the pair of fasteners fastened together so as to fasten said tapping apparatus onto the portion of human body.

3. The massaging device of claim 1, wherein said actuating element is electrically connected with a control unit via wires.

4. The massaging device of claim 1, wherein said elastic connecting assembly includes a connecting plate defining a plurality of through holes symmetrically around the periphery thereof, a plurality of guiding rods, and a plurality of springs, each said guiding rod being slidably inserted in a respective through hole of said connecting plate at one end thereof and fixedly connected to said flat tapping pad at the other end thereof, each said spring being fitted around a respective guiding rod between said connecting plate and said flat tapping pad; whereby, when said flat tapping pad taps a portion of human body, said springs each can exert a counteracting force to said connecting plate to enable said flat tapping pad to have a uniform pressure distribution over entire surface of said flat tapping pad in contact with the portion of human body so that the effect of shaping body and reducing weight can be improved.

5. The massaging device of claim 4, wherein two washers are fitted around each said guiding rod at two ends of the respective spring.

6. The massaging device of claim 4, wherein at least one spring is connected between said connecting plate and said case.

7. The massaging device of claim 6, wherein said spring connected between said connecting plate and said case is an extension spring.

8. The massaging device of claim 4, wherein said spring fitted around each said guiding rod is a compression spring.

9. The massaging device of claim 1, wherein said flat tapping pad is made of elastic material.

10. The massaging device of claim 1, wherein said flat tapping pad is formed with a plurality of massage heads on the surface in contact with a portion of human body.
